(19) United States
(12) Patent Application Publication
(10) Pub. No.: US 2009/0058633 A1
(43) Pub. Date: Mar. 5, 2009

(54) ANC NOTCH FILTER ADAPTATION SYSTEM AND METHOD FOR HANDLING ROAD NOISE PEAK SHIFTS IN A MOTOR VEHICLE

(75) Inventors: Liping Luo, Marietta, GA (US); Yoshio Nakamura, Osaka (JP); Daizo Ando, West Bloomfield, MI (US)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 11/848,853

(22) Filed: Aug. 31, 2007

(51) Int. Cl. G08B 1/08

(52) U.S. Cl. 340/538.12

(57) ABSTRACT

A notch filter adaptation system for use with an active noise control system of a motor vehicle has a parameters determination module receiving data from a bus of a vehicle and employing the data to determine one or more parameters for a notch filter. The data can include vehicle type, tire diameter, tire cavity, and/or ambient temperature. The parameters can include one or more notch filter peak frequency values, one or more notch filter Q values, and/or modifications of predetermined peak frequency values and/or Q values. An active noise control module can employ the parameters to generate opposite phase noise in the vehicle according to one or more notch filters having frequency bands at least in part specified by the parameters.

### FIELD

The present disclosure generally relates to active noise cancellation in an automotive vehicle, and relates in particular to systems and methods for dynamically modifying a notch filter in active road noise cancellation.

### BACKGROUND

The statements in this section merely provide background information related to the present disclosure and may not constitute prior art.

Active noise cancellation has been used in automotive vehicles to cancel road noise. Some systems employ speakers located in a cabin of the vehicle and connected to a vehicle bus. Some of these systems employ a microphone in the vehicle cabin to measure road noise in the vehicle cabin. Then, the system can generate sound in the vehicle cabin by the speakers that is a copy of at least part of the road noise but of opposite phase, thus destructively interfering with the road noise.

Due to delay in the ability to measure and generate the noise, and due to limitations of the microphone in measuring the noise, and due to other factors, the active noise cancellation is not perfect. In particular, a noise peak can still be substantially audible to vehicle users. Therefore, a notch filter has been applied across the noise peak in order to reduce the road noise in this area in a predetermined fashion. This notch filter has been adapted by using the microphone input to measure error in the cabin. Also, amplitude of the notch filter has been adapted to prevent exceeding limitations of the speakers, causing damage to user hearing, and causing unpleasant noise, especially when the user is also employing the speakers to generate sound from an entertainment system of the vehicle. These and other techniques for limiting the active noise cancellation and/or notch filter thereof are described in U.S. Pat. No. 6,891,954 and in U.S. Pat. Pub. Nos: 2004/0240677; 2004/0240678; 2004/0247137; 2004/0258251; 2004/0258252; and 2005/0053244. The disclosures of the aforementioned U.S. patents and U.S. patent application Publications are incorporated herein by reference in their entirety for any purpose.

As discussed in U.S. Pat. Pub. No. 2005/0053244, systems have been proposed as active noise cancellation systems whereby a noise-canceling signal is emitted or outputted from a speaker or the like by using a digital signal processing technique, and the noise at a listening position (evaluation point) at which a microphone or the like is installed is reduced (see Japanese Domestic Republication No. 1-501344 that is corresponding to PCT/GB87/00706 (FIG. 1 and others) and Japanese Laid-Open Patent Application No. 6-332477 (FIG. 1 and others)).

The technique described in Japanese Domestic Republication No. 1-501344 is configured such that a plurality of speakers as canceling signal emitters and microphones as error signal detectors are disposed in the passenger compartment of a vehicle, the cabin of an aircraft, or another enclosed space, and noise is reduced in the entire enclosed space of the vehicle passenger compartment or the like.

Specifically, this type of noise cancellation system essentially employs feedforward control using an adaptive filter to emit a signal from a speaker so as to minimize an error signal that indicates residual vibration or noise due to the interference between a noise and the canceling signal in the mounting position of the microphone, and therefore has the drawback of being incapable of adequately reducing noise that is located away from the microphone.

The technique described in Japanese Domestic Republication No. 1-501344 is therefore designed such that the control area in which noise can be reduced is extended from a point to a space, and noise can be reduced throughout an enclosed area by installing a plurality of microphones and performing control such that the summation of the error signals detected by each microphone is minimized.

However, because the microphones are generally mounted to the inside of the roof (ceiling) or to the seat backs (rear surfaces of the seats) in order to reduce noise near occupants' ears, increasing the number of microphones not only increases the number of parts, but leads to an increase in work to provide complicated wiring to the microphones and in the computational load involved in updating the filter coefficient of the adaptive filter, and contributes to increased cost.

A technique is proposed in Japanese Laid-Open Patent Application No. 6-332477 for reducing noise in a position other than the mounting position of the microphone (evaluation point). As shown particularly in FIG. 1 of this publication, a technique is proposed whereby a filter circuit (FIR) 5 is provided between the adaptive filter 2 and the second speaker 6b, and noise at a control point (point A) other than the microphone mounting position is reduced by the output of the second speaker 6b by setting the filter coefficient of the filter circuit to the transfer characteristic G from the microphone (error detection means) 1b to the point (point A) controlled by the second speaker. Specifically, using the passenger compartment of a vehicle as an example, the technique disclosed in this prior art ('477) is a technique whereby noise is reduced at the control point (point A) on the rear seat merely by using the microphone used for the front seats.

However, although the transfer characteristic C from the first speaker 6a to the microphone 1b is set as the filter coefficient of the FIR filter 3, and the transfer characteristic from the second speaker 6b to the control point (point A) is approximated by the same characteristic as C in the active noise cancellation system disclosed in ('477), since only the transfer characteristic G from the microphone 1b to the control point (point A) is set as the filter coefficient of the filter circuit 5, this technique has drawbacks in that the microphone 1b is actually affected by the output sound from the second speaker 6b to make it impossible to effectively reduce noise at the mounting position of the microphone 1b, and also the control point (point A) is affected by the output sound from the first speaker 6a to make it impossible to reduce noise at the control point in an effective manner.

In other words, the active noise cancellation system disclosed in FIG. 1 of ('477) has the drawback of not being able to effectively reduce noise because neither the transfer characteristic from the first speaker 6a to the control point (point A), nor the transfer characteristic from the second speaker 6b to the mounting position of the microphone 1b, or the so-called cross term, is taken into account in the filter coefficient of the filter circuit 5.

U.S. Pat. Pub. No. 2005/0053244 overcomes the above-mentioned drawbacks, and provides an active noise cancellation system that is configured so as to reduce the number of microphones for error signal detection and avoid the above-mentioned increase in parts, the increase in the amount of work to provide complicated wiring to the microphones, and the increase in the computational load involved in updating the filter coefficient of the adaptive filter, while enabling to maintain an area in which noise can be reduced to the same level as that obtained before reducing the number of microphones.

U.S. Pat. Pub. No. 2005/0053244 teaches an active noise cancellation system having a base signal generator that generates a base signal composed of a harmonic having a frequency selected from a frequency of vibration or noise produced from a vibration or noise source. An adaptive filter outputs a control signal based on the base signal. A first canceling signal emitter emits a canceling signal for canceling out the vibration or noise generated based on the control signal. An error signal detector detects a residual vibration or noise at an evaluation point due to interference between the emitted canceling signal and the produced vibration or noise, as an error signal. A correction filter corrects the base signal, by a correction value indicating a transfer characteristic of the produced vibration or noise that corresponds to the harmonic frequency of the base signal from the first canceling signal emitter to the error signal detector, to generate a reference signal. A filter coefficient updater successively updates a filter coefficient of the adaptive filter based on the error signal and the reference signal such that the error signal is minimized. A compensation filter corrects the control signal by a prescribed value. A second canceling signal emitter emits the canceling signal generated based on the corrected control signal. The correction value of the correction filter is set to a sum obtained by adding the transfer characteristic from the first canceling signal emitter to the error signal detector, and a product obtained by multiplying the transfer characteristic from the second canceling signal emitter to the error signal detector by the prescribed value.

### SUMMARY

A notch filter adaptation system for use with an active noise control system of a motor vehicle has a parameters determination module receiving data from a bus of a vehicle and employing the data to determine one or more parameters for a notch filter. The data can include vehicle type, tire diameter, tire cavity, and/or ambient temperature. The parameters can include one or more notch filter peak frequency values, one or more notch filter Q values, and/or modifications of predetermined peak frequency values and/or Q values. An active noise control module can employ the parameters to generate opposite phase noise in the vehicle according to one or more notch filters having frequency bands at least in part specified by the parameters.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1, including FIGS. 1A and 1B, is a set of block diagrams illustrating an active noise control system of a motor vehicle.

FIG. 2, including FIGS. 2A and 2B, is a set of graphical representations illustrating shift of a road noise peak due to ambient temperature.

FIG. 3, including FIGS. 3A-3C, is a set of lookup maps storing noise peaks by temperature, tire diameter, and tire cavity.

FIG. 4, including FIGS. 4A-4C, is a set of flow diagrams illustrating use of data received from a vehicle CAN bus, such as ambient temperature, tire diameter, and tire cavity, to determine an active noise control target band and generate a corresponding output from an active noise control system.

FIG. 5 is a block diagram illustrating a notch filter adaptation system for use with an active noise control system of a motor vehicle.

FIG. 6 is a block diagram illustrating a matrix data structure storing notch filter parameters by vehicle type, tire diameters, tire cavities, and temperatures.

FIG. 7 is a flow diagram illustrating a notch filter adaptation method for use with an active noise control system of a motor vehicle.

### DETAILED DESCRIPTION

The following description is merely exemplary in nature and is not intended to limit the present disclosure, application, or uses.

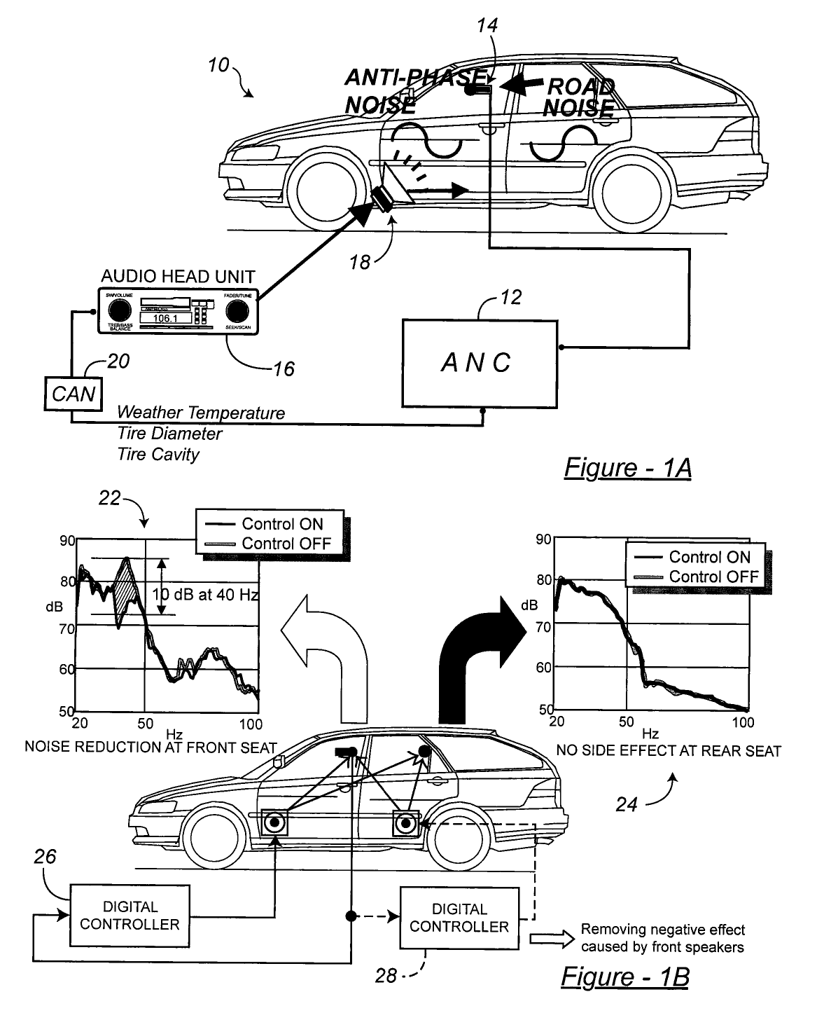

Referring generally to FIGS. 1A and 1B, a motor vehicle 10 can have an active noise control system 12 with a microphone 14 in a cabin of the vehicle 10 to sense road noise. The active noise control system 12 can control an audio head unit 16 in the vehicle to drive speakers 18 in the vehicle 10 in order to generate sound in the vehicle 10 that destructively interferes with the road noise. For example, the active noise control system 12 can generate opposite phase sound in the vehicle across one or more frequency spectra in order to reduce road noise at noise peaks. A frequency spectrum can be distributed about a noise peak frequency according to a Q value. Thus, a notch filter is accomplished. The peak frequency and/or Q value can be dynamically determined and/or adjusted based on information received from a CAN bus 20 of the vehicle 10, such as weather temperature, tire diameter, and/or tire cavity.

Some embodiments can reduce noise at a front seat of the vehicle 10 as at 22, while avoiding a side effect at a rear seat of the vehicle as at 24. For example, one digital controller 26 having a microphone in a front of the vehicle cabin can drive a speaker in the front of the vehicle cabin to cancel the road noise. Synchronously, another digital controller 28 having its own microphone in a rear of the vehicle cabin can drive a speaker in the rear of the vehicle cabin to remove any negative effect caused by the front speakers. For example, a noise peak in the range of human hearing can be present at the front seat, while this noise peak can be absent at the rear seat. But the use of digital controller 28 to cancel the opposite phase noise at the rear seat can avoid production of an opposite phase noise peak at a rear seat.

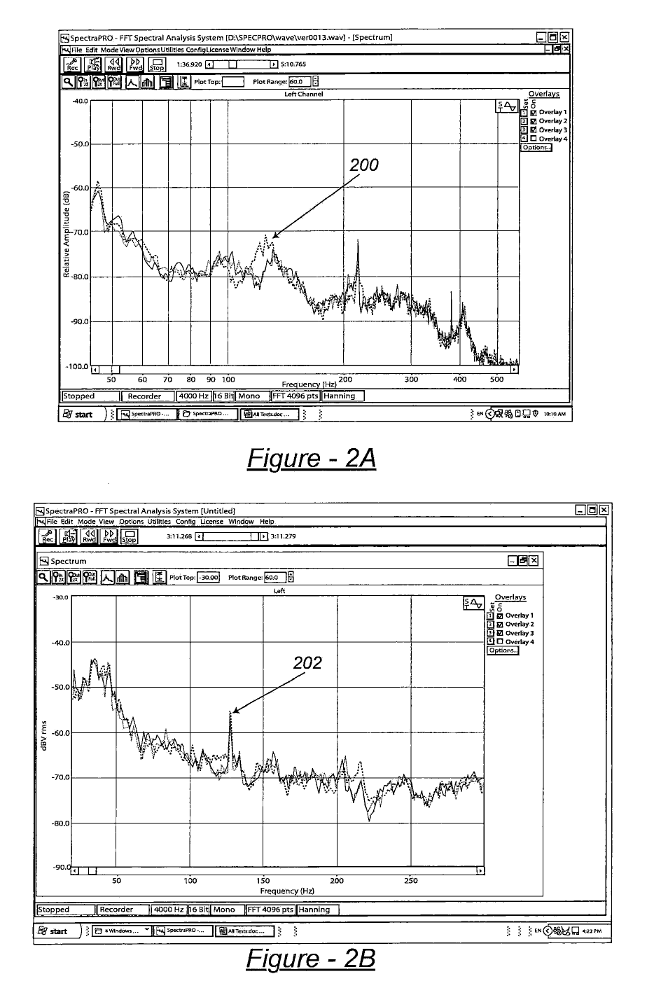

Turning now to FIGS. 2A and 2B and referring generally thereto, a frequency of a noise peak 200 can measured at a particular ambient temperature during testing. Thus, so long as the current ambient temperature remains at or near the tested ambient temperature, the noise peak 200 can be reduced by use of a notch filter at the noise peak frequency. However, when the temperature changes greatly, the noise peak frequency can shift as at 202. For example, if the temperature changes from forty-six degrees Fahrenheit to eighty-six degrees Fahrenheit, the noise peak can shift from one-hundred twenty Hertz to one-hundred twenty-eight Hertz. When this shift occurs, application of the notch filter designed for the test ambient temperature of forty-six degrees Fahrenheit can fail to reduce the road noise at the shifted peak frequency of one-hundred twenty-eight Hertz. Moreover, continued production of the opposite phase sound at the peak frequency of one-hundred twenty Hertz can actually increase the perceived road noise at that frequency. Accordingly, shifting the notch filter peak frequency based on ambient temperature measured by a vehicle sensor can greatly improve the effectiveness of the notch filter in canceling road noise at the shifted road noise peak.

In addition to temperature, there are other factors that can shift road noise peaks. For example, tire diameter can have an effect on the road noise peak. Also, tire cavity can have an effect on road noise peak. Thus, when tires are changed, the notch filter designed for the previous set of tires can fail to reduce the perceived road noise at the new peak frequency. However, the tire diameter and tire cavity information can be input to the vehicle ECU by a vehicle maintenance technician upon change of the tire so that speedometers and other vehicle components can be adjusted accordingly. Therefore, it can also be possible to obtain these types of information from the vehicle CAN bus, and shift the notch filter peak frequency to improve the effectiveness of the notch filter in canceling road noise at the shifted road noise peak.

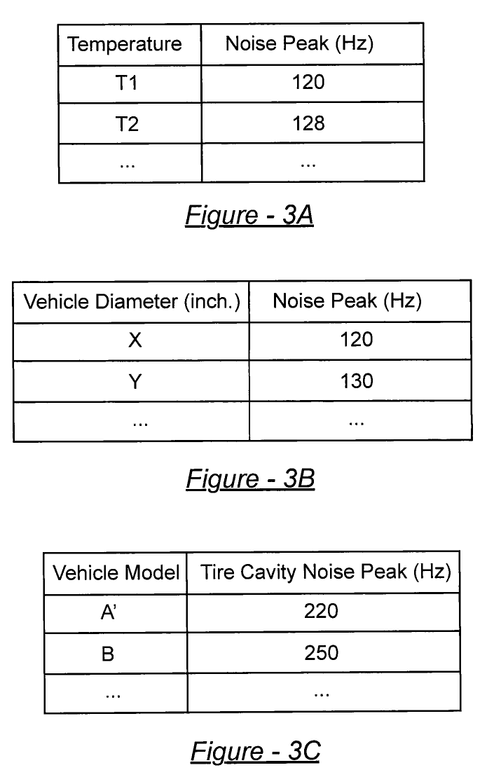

Turning now to FIGS. 3A-3C and referring generally thereto, road noise characteristics, such as road noise peak frequency, can be measured during testing for various vehicle models at various ambient temperatures, tire diameters, and/or tire cavities. A data structure, such as a map table, can then be constructed that relates one or more of these factors to road noise peak frequency. In some embodiments, the map table can be vehicle model specific. Therefore, one or more of these factors, such as ambient temperature, can be related to noise peak frequency for one or more vehicle models that experience similar noise peak shifts (FIG. 3A). In additional or alternative embodiments, the map table can be developed for standard equipment for particular vehicle models. Therefore, one or more of these factors, such as standard tire diameters on various vehicle models, can be related to noise peak frequency (FIG. 3B). In additional or alternative embodiments, the map table can be factor specific. Therefore, vehicle models can be related to noise peak frequency for a value or set of values for one or more of these factors, such as tire cavity (FIG. 3C).

It should also be readily understood that there can be more than one road noise peak and more than one notch filter. For example, there can be a road noise peak that shifts in the frequency range of 120 to 180 hertz (FIGS. 3A and 3B), and another road noise peak that shifts in the frequency range of 220 to 280 hertz (FIG. 3C). Accordingly, there can be more than one map table and/or more than one noise peak frequency reported in the map table. Moreover, the relevant factors for each of the peak shifts can be peak shifts can be determined for each road noise peak. For example, shift of a road noise peak can be entirely or mostly based on temperature and tire diameter for one road noise peak (FIGS. 3A and 3B), while shift of another road noise peak can be entirely or mostly based on tire cavity (FIG. 3C). Thus, the factors can be accommodated for the road noise peaks on an individual basis.

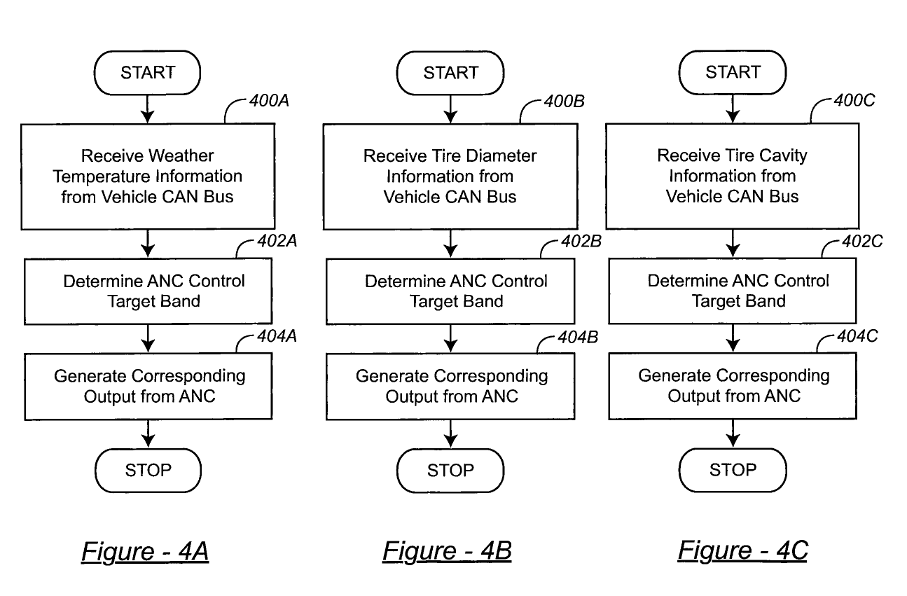

Turning now to FIGS. 4A-4C and referring generally thereto, information received from the vehicle CAN bus at steps 400A, 400B, and 400C can be used to determine one or more ANC target bands at steps 402A, 402B, and 402C. The one or more ANC target band can then be used to apply one or more notch filters by generating corresponding output from the ANC at steps 404A, 404B, and 404C. For example, ambient weather temperature value can be received form the CAN bus at step 400A and used to determine one or more ANC target bands at step 400B. Similarly, tire diameter information can be received from the vehicle CAN bus at step 402A and used to determine one or more ANC target bands at step 402B. Also, tire cavity information can be received from the vehicle CAN bus at step 404A and used to determine one or more ANC target bands at step 404B.

It should be readily understood that, in some embodiments, the ambient weather temperature can be sensed by a sensor of the vehicle that is connected to the vehicle CAN bus. Additionally or alternatively, it should be readily understood that, in some embodiments, the ambient weather temperature can be reported by one or more other systems connected to the vehicle CAN bus, such as a satellite radio receiving weather updates by location, and/or a vehicle GPS determining the vehicle location and accessing weather information for the vehicle location. It should also be readily understood that, in additional or alternative embodiments, the tire cavity and/or tire diameter can be stored in non-volatile memory of an ECU of the vehicle that is connected to the vehicle CAN bus. It should further be readily understood that, in additional or alternative embodiments, the tire diameter and/or tire cavity information stored in the vehicle ECU can be initially stored in the vehicle ECU at time of vehicle manufacture. Still further, it should be readily understood that, in additional or alternative embodiments, the tire diameter and/or tire cavity information stored in the vehicle ECU can be updated by a technician changing tires.

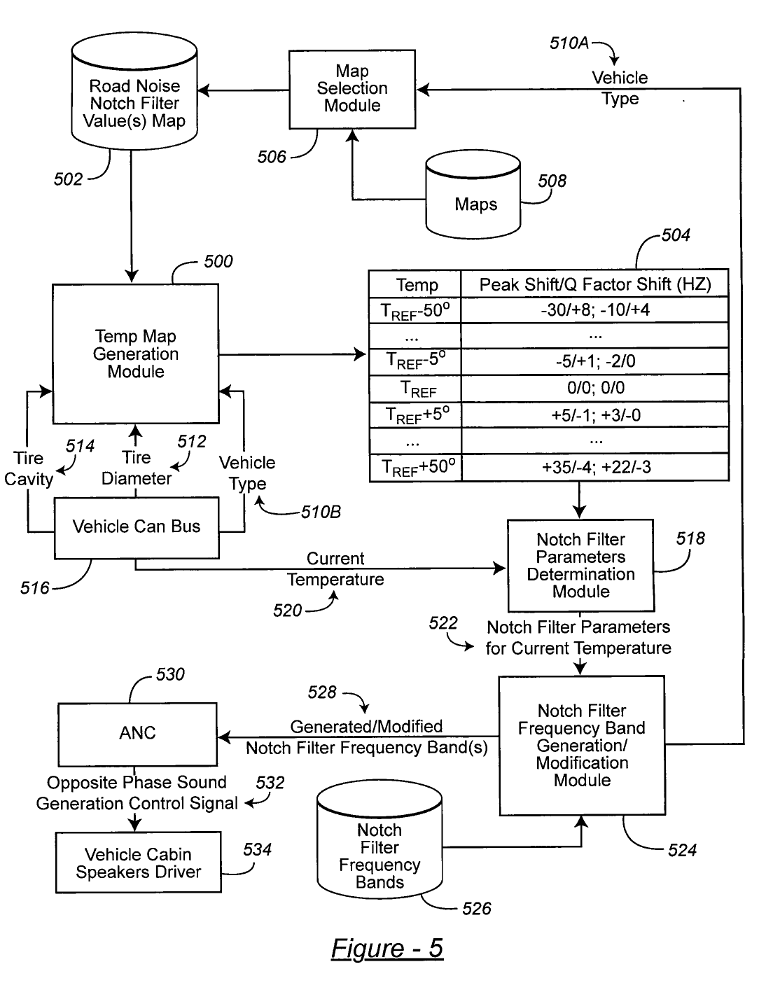

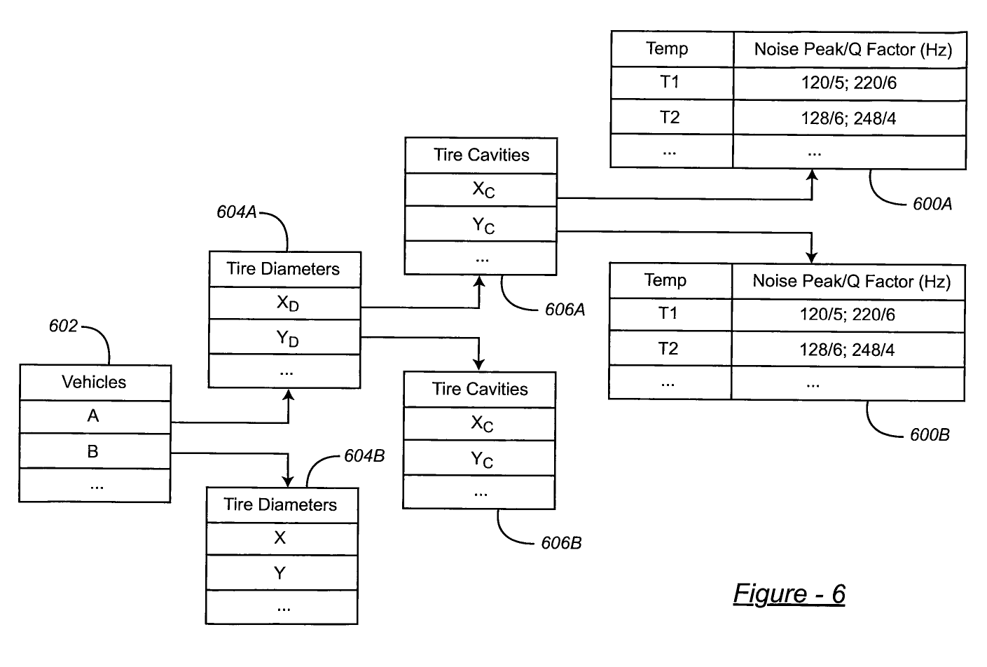

Turning now to FIG. 5, some embodiments can have a notch filter parameters map 502 or maps. Referring briefly to FIGS. 4 and 6, the map or maps can be a set of one dimensional data structures and/or a multidimensional or hierarchical data structure. These data structures can provide notch filter parameters for various combinations of vehicle type, tire diameter, tire cavity, and/or temperature. Returning now to FIG. 5, temperature map generation module 500 that can employ the map 502 or maps to generate a temperature map 504 for one or more peak shifts. In some embodiments, a map selection module 506 can select one or more of maps 508 by vehicle type information 510A. In such embodiments, the selected one or more of maps 508 can be stored as map 502 and used thereafter by module 500. In alternative or additional embodiments, map selection module can select one of maps 508 to be map 502 by tire diameter information and/or tire cavity information stored in the ANC or a pin combination set in the ANC at time of installation of the ANC, and these data can be determined according to standard vehicle equipment for a particular vehicle model. Some of these embodiments can determine the vehicle type information 510A, tire diameter information, and/or tire cavity information by, for example, information stored in the ANC or a pin combination set in the ANC at time of installation in of the ANC in the vehicle. In alternative or additional embodiments, map 502 can be accessible by vehicle type information 510B, tire diameter information 512, and/or tire cavity information 514 received from the vehicle CAN bus 516. In still alternative or additional embodiments, the map 502 can simply be developed for a particular vehicle model, tire diameter, and/or tire cavity.

In some embodiments, temperature map generation module 500 can generate the temperature map 504 at time of vehicle startup and/or when it detects a change in tire diameter information 512 and/or tire cavity information 514. Thereafter, the temperature map 504 can be dynamically accessed by notch filter parameter determination module 518 by ambient temperature information 520 that is continuously or periodically received from the vehicle CAN bus 516. Accordingly, module 518 can retrieve notch filter parameters 522 for the current temperature that are pre-adjusted for vehicle type, tire diameter, and/or tire cavity.

In some embodiments the notch filter parameters arranged by temperature in map 504 can include the peak frequency and a suitable Q value for the filter at that vehicle type, temperature, tire diameter, and/or tire cavity, and parameters for more than one notch filter can be stored and retrieved. Like the peak frequency for each road noise peak, the suitable Q value for each road noise peak can be determined experimentally for various combinations of vehicle type, tire diameter, tire cavity, and ambient temperature. In some embodiments, maps 502, 504, and 508 can store modifications to a predetermined notch filter peak frequency and/or Q value. For the tire diameter, tire diameter, and/or tire cavity, the predetermined notch filter peak frequency and/or Q value can be stored in a vehicle specific map in association with a reference tire diameter, tire cavity, and/or temperature.

Turning briefly to FIG. 6, the peak frequencies and/or Q values can alternatively or additionally be stored as notch filter peak frequency values and notch filter frequency range widths as in temperature maps 600A and 600B. These and/or other maps storing notch filter parameters can be arranged in a data structure, such as a multidimensional data structure (e.g., matrix data structure) and/or hierarchical data structure (e.g., tree data structure). These and other data structures can store notch filter parameters measured for various test values obtained for each combination of vehicle type, tire diameter, tire cavity, and/or ambient temperature. For example, cells of an array 602 arranged by vehicle types can contain pointers to arrays 604A and 604B arranged by tire diameter values. Similarly, cells of arrays 604A and 604B can contain pointers to arrays 606A and 606B arranged by tire cavity values, and cells of arrays 606A and 606B can contain pointers to maps 600A and 600B, which can be arrays of notch filter parameters arranged by temperature values. In such embodiments, notch filter parameters can be retrieved for any combination of vehicle type, tire diameter value, tire cavity value, and/or temperature. Placing temperature maps 600A and 600B in the final dimension of the matrix or leaves of a tree, for example, allows the temperature map to be quickly and easily retrieved by the vehicle type, tire diameter value, and/or tire cavity value at time of vehicle manufacture, ANC system installation, tire change, and/or vehicle startup. Retrieving the temperature map and using it thereafter permits retrieval of notch filter parameters without needing to reference each dimension or level of the data structure, and it can promote faster retrieval and lower overhead during vehicle operation.

Returning now to FIG. 5, in some embodiments, the notch filter parameters 522 can be used by notch filter frequency band generation/modification module 524 to select a notch filter or set of notch filters 526 to be generated and/or modified. The resulting one or more notch filter frequency bands 528 can thereafter be output from module 524. It should be readily understood that some embodiments can retrieve one or more explicitly specified frequency bands from map 504 as parameters 522. For definitional purposes, it should be understood that an explicitly specified frequency band inherently specifies the peak frequency in the middle of the band, and inherently specifies the Q value, which is equal half the width of the frequency band. In the case that the notch filter parameters are one or more notch filter frequency bands, the notch filter parameters 522 can be used directly as the one notch filter frequency bands 528. In any event, the ANC 530 can receive the notch filter frequency bands 528 and generate an opposite phase sound generation control signal 532 that operates vehicle cabin speakers driver 534 to generate the opposite phase noise in the specified frequency bands 528 within the vehicle cabin.

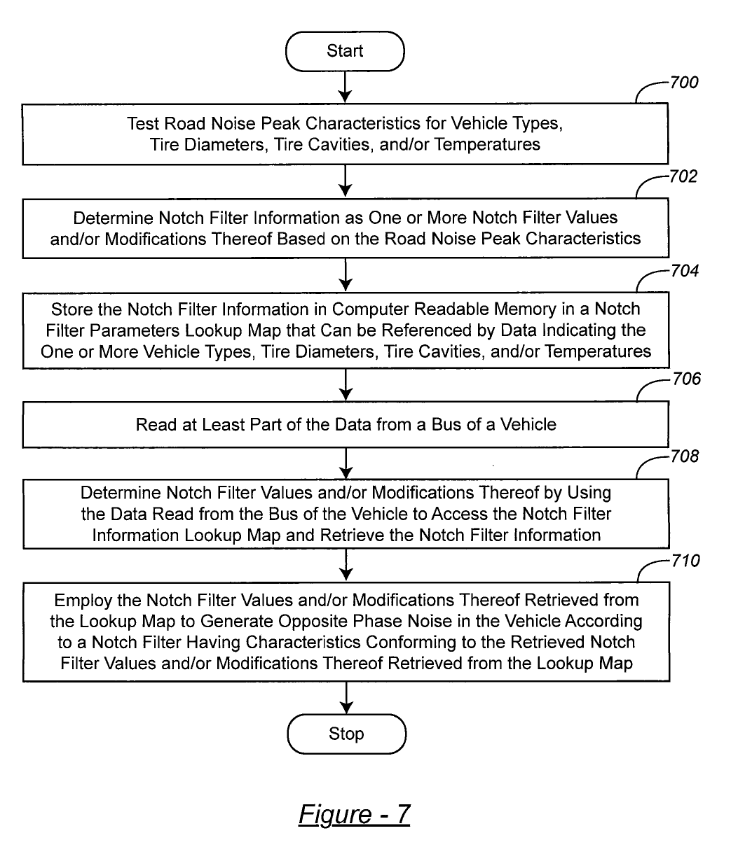

Turning finally to FIG. 7, a notch filter adaptation method for use with an active noise control system of a motor vehicle can include testing road noise peak characteristics for one or more road noise peaks at step 700. Characteristics that can be tested include a road noise peak frequency, a road noise peak width, and/or a road noise peak frequency band. The characteristics can be tested for vehicle types, tire diameters, tire cavities, ambient temperatures, or combinations thereof.

From the road noise peak characteristics, notch filter parameters can be determined as notch filter values or modifications thereof at step 702. These notch filter parameters can be notch filter peak frequencies, notch filter Q values, and/or a notch filter frequency band. In some embodiments, step 700 can be performed to identify a road noise peak frequency, and a suitable Q value for the notch filter can be determined by applying a notch filter at the peak frequency and adjusting the notch filter Q value until one or more Q values are found that best achieve cancellation of the road noise peak.

The notch filter parameters determined in step 702 can be stored in a data structure in computer readable memory at step 704. In some embodiments, this data structure can be a notch filter parameters lookup map that can be referenced by data indicating one or more vehicle types, tire diameter values, tire cavity values, and/or ambient temperature values. In some embodiments, the data structure can be multidimensional and/or hierarchical data structure that stores notch filter parameters specific to one or more combinations of the vehicle types, tire diameter values, tire cavity values, and/or ambient temperature values.

Data for referencing the data structure can be received from a bus of a vehicle at step 706. This data can include all or part of the vehicle types, tire diameter values, tire cavity values, and/or ambient temperature values. This data can then be used at step 708 to reference the data structure and retrieve one or more notch filter parameters that have been determined for use in generating or modifying one or more notch filters under conditions indicated by the data. With the notch filter parameters retrieved at step 708, one or more notch filters can be generated or modified at step 710 and used to generate opposite phase noise in the vehicle. The opposite phase noise can be generated according to one or more frequency bands of the one or more notch filters. These frequency bands can be at least partly specified by the one or more notch filter parameters retrieved from the data structure.

What is claimed is:

1. A notch filter adaptation system for use with an active noise control system of a motor vehicle, the method comprising:
a notch filter parameters determination module receiving data and employing the data to determine at least one parameter for a notch filter, wherein
the data include at least one of: (a) vehicle type; (b) tire diameter; (c) tire cavity; or (d) ambient temperature, and
the at least one parameter includes at least one of: (a) at least one notch filter peak frequency value; (b) at least one modification of at least one predetermined notch filter peak frequency value; (c) at least one notch filter Q value; or (d) at least one modification of at least one predetermined notch filter Q value; and
an active noise control module employing the at least one parameter to generate opposite phase noise in the vehicle according to at least one notch filter having at least one frequency band specified at least in part by the at least one parameter.

2. The system of claim 1, further comprising a data store in computer readable memory and containing a data structure accessible by the data to retrieve the parameters, wherein the parameters retrievable by the data have been predetermined by testing at least one road noise peak characteristic for a plurality of at least one of: (a) vehicle types; (b) tire diameters; (c) tire cavities; or (d) ambient temperatures,
wherein said parameters determination module employs the data to access the data structure and retrieve the at least one parameter.

3. The system of claim 2, wherein the parameters retrievable by the data have been predetermined by testing the at least one road noise peak characteristic for the plurality of vehicle types.

4. The system of claim 2, wherein the parameters retrievable by the data have been predetermined by testing the at least one road noise peak characteristic for the plurality of tire diameters.

5. The system of claim 2, wherein the parameters retrievable by the data have been predetermined by testing the at least one road noise peak characteristic for the plurality of tire cavities.

6. The system of claim 2, wherein the parameters retrievable by the data have been predetermined by testing the at least one road noise peak characteristic for the plurality of ambient temperatures.

7. The system of claim 1, wherein the data includes the vehicle type.

8. The system of claim 1, wherein the data includes the tire diameter.

9. The system of claim 1, wherein the data includes the tire cavity.

10. The system of claim 1, wherein the data includes the ambient temperature.

11. The system of claim 1, wherein the at least one parameter includes the at least one notch filter peak frequency value.

12. The system of claim 1, wherein the at least one parameter includes the at least one modification of the predetermined notch filter peak frequency value.

13. The system of claim 1, wherein the at least one parameter includes the at least one notch filter Q value.

14. The system of claim 1, wherein the at least one parameter includes the at least one modification of the predetermined notch filter Q value.

15. The system of claim 1, wherein the data include the tire diameter, the tire cavity, and the ambient temperature, and the at least one parameter includes the at least one frequency band.

16. The system of claim 1, wherein said notch filter parameters determination module receives the data from a bus of the vehicle.

17. A notch filter adaptation method for use with an active noise control system of a motor vehicle, the method comprising:
receiving data, including receiving at least one of:
(a) vehicle type
(b) tire diameter;
(c) tire cavity; or
(d) ambient temperature;
employing the data to determine at least one parameter for a notch filter including at least one of:
(a) at least one notch filter peak frequency value;
(b) at least one modification of at least one predetermined notch filter peak frequency value;
(c) at least one notch filter Q value; or
(d) at least one modification of at least one predetermined notch filter Q value; and
employing the at least one parameter to generate opposite phase noise in the vehicle according to at least one notch filter having at least one frequency band specified at least in part by the at least one parameter.

18. The method of claim 17, further comprising:
testing at least one road noise peak characteristic for a plurality of at least one of:
(a) vehicle types;
(b) tire diameters;
(c) tire cavities; or
(d) ambient temperatures;
determining a plurality of the parameters based on the one or more road noise peak characteristics obtained by said testing;
storing the plurality of parameters in computer readable memory in a data structure accessible by the data; and
employing the data to access the data structure and retrieve the at least one parameter.

19. The method of claim 18, wherein testing the least one road noise peak characteristic includes testing the at least one road noise peak characteristic for the plurality of vehicle types.

20. The method of claim 18, wherein testing the least one road noise peak characteristic includes testing the at least one road noise peak characteristic for the plurality of tire diameters.

21. The method of claim 18, wherein testing the least one road noise peak characteristic includes testing the at least one road noise peak characteristic for the plurality of tire cavities.

22. The method of claim 18, wherein testing the least one road noise peak characteristic includes testing the at least one road noise peak characteristic for the plurality of ambient temperatures.

23. The method of claim 17, wherein receiving the data includes receiving the vehicle type.

24. The method of claim 17, wherein receiving the data includes receiving the tire diameter.

25. The method of claim 17, wherein receiving the data includes receiving the tire cavity.

26. The method of claim 17, wherein receiving the data includes receiving the ambient temperature.

27. The method of claim 17, wherein employing the data to determine the at least one parameter includes employing the data to determine the at least one notch filter peak frequency value.

28. The method of claim 17, wherein employing the data to determine the at least one parameter includes employing the data to determine the at least one modification of the predetermined notch filter peak frequency value.

29. The method of claim 17, wherein employing the data to determine the at least one parameter includes employing the data to determine the at least one notch filter Q value.

30. The method of claim 17, wherein employing the data to determine the at least one parameter includes employing the data to determine the at least one modification of the predetermined notch filter Q value.

31. The method of claim 17, wherein the data include the tire diameter, the tire cavity, and the ambient temperature, and the at least one parameter determined by employing the data includes the at least one frequency band.

32. The method of claim 17, further comprising receiving the data from a bus of the vehicle.

33. A method for actively cancelling road noise in a motor vehicle, the method comprising:
receiving data indicative of tire diameter;
determining a parameter of a notch filter based on the tire diameter data; and
performing noise cancellation in the vehicle using the notch filter.

34. The method of claim 33, further comprising:
testing at least one road noise peak characteristic for a plurality of tire diameters;
determining a plurality of the parameters based on the one or more road noise peak characteristics;
storing the plurality of parameters in computer readable memory in a data structure accessible by the tire diameter data; and
employing the tire diameter data to access the data structure and retrieve the at least one parameter.

35. The method of claim 33, further comprising:
receiving data indicative of tire cavity; and
determining the parameter based on the tire cavity data.

36. The method of claim 33, further comprising:
receiving data indicative of ambient temperature; and
determining the parameter based on the ambient temperature data.

37. A method for actively cancelling road noise in a motor vehicle, the method comprising:
receiving data indicative of ambient temperature;
determining a parameter of a notch filter based on the ambient temperature data; and
performing noise cancellation in the vehicle using the notch filter.

38. The method of claim 37, further comprising:
testing at least one road noise peak characteristic for a plurality of ambient temperatures;
determining a plurality of the parameters based on the one or more road noise peak characteristics;
storing the plurality of parameters in computer readable memory in a data structure accessible by the ambient temperature data; and
employing the ambient temperature data to access the data structure and retrieve the at least one parameter.

39. The method of claim 37, further comprising:
receiving data indicative of tire cavity; and
determining the parameter based on the tire cavity data.

40. The method of claim 37, further comprising:
receiving data indicative of tire diameter; and
determining the parameter based on the tire diameter data.

41. A method for actively cancelling road noise in a motor vehicle, the method comprising:
receiving data indicative of tire cavity;
determining a parameter of a notch filter based on the tire cavity data; and
performing noise cancellation in the vehicle using the notch filter.

42. The method of claim 41, further comprising:
testing at least one road noise peak characteristic for a plurality of tire cavities;
determining a plurality of the parameters based on the one or more road noise peak characteristics;
storing the plurality of parameters in computer readable memory in a data structure accessible by the tire cavity data; and
employing the ambient temperature data to access the data structure and retrieve the at least one parameter.

43. The method of claim 41, further comprising:
receiving data indicative of ambient temperature; and
determining the parameter based on the ambient temperature data.

44. The method of claim 41, further comprising:
receiving data indicative of tire diameter; and
determining the parameter based on the tire diameter data.
